(19) United States
(12) Patent Application Publication
(10) Pub. No.: US 2012/0179583 A1
(43) Pub. Date: Jul. 12, 2012

(54) Electronic Commerce Platform with Staging to Production and Bundles

(76) Inventors: Ivan Jensen, Vancouver (CA); Simon Droscher, Vancouver (CA); Michael Vax, Vancouver (CA)

(21) Appl. No.: 13/346,523

(22) Filed: Jan. 9, 2012

Related U.S. Application Data
(60) Provisional application No. 61/431,369, filed on Jan. 10, 2011.

(51) Int. Cl. G06Q 30/06

(52) U.S. Cl. 705/27.1

(57) ABSTRACT

An electronic commerce system with staging to production and bundles is provided. In one embodiment, the electronic commerce system comprises a storefront server system configured to serve a virtual storefront over a computer network for display on each of a plurality of client devices, a data store in which virtual storefront data for serving the virtual storefront is stored, a staging server system configured to receive one or more change sets from a user of a commerce manager client, the change set comprising changes to the one or more objects. The system further comprises and a synchronization program configured to generate a job description comprising one or more instructions to effect the one or more changes and a production server system configured to receive the job description via the synchronization program and modify the virtual storefront data to reflect the job description and the one or more change sets.

### CROSS REFERENCE TO RELATED APPLICATIONS

This application is based on and claims priority to U.S. Provisional Patent Application Ser. No. 61/431,369, entitled ELECTRONIC COMMERCE PLATFORM WITH STAGING TO PRODUCTION, BUNDLES AND PRICE LISTS, and filed Jan. 10, 2011, the entire disclosure of which is herein incorporated by reference.

### BACKGROUND

Electronic commerce platforms enable vendors to sell their products online. For a vendor, managing the presentation of large numbers of products in online stores can be time consuming, particularly when new products are added, former products are deleted, or current products change attributes, such as price. When the data is not managed properly, errors can crop up, which may be exposed to a shopper engaged in an e-commerce transaction. Such errors may result in a lost sale, and generally degrade the shopper's confidence in the online shopping experience.

### SUMMARY

An electronic commerce system with staging to production, bundles, and price lists is provided. In one example embodiment, an electronic commerce system comprises a storefront server system configured to serve a virtual storefront over a computer network for display on each of a plurality of client devices, and a data store in which virtual storefront data for serving the virtual storefront is stored, the virtual storefront data including one or more objects grouped to each other having one or more dependencies among them. The electronic commerce system further comprises a staging server system configured to receive one or more change sets from a user of a commerce manager client, the change set comprising changes to the one or more objects, and a synchronization program configured to generate a job description comprising one or more instructions to effect the one or more changes, generating the job description comprising resolving conflicts within the change sets and conflicts between the change sets, merging the change sets, and ordering the changes included in the one or more changes sets. The electronic commerce system also comprises a production server system configured to receive the job description via the synchronization program and modify the virtual storefront data to reflect the job description and the one or more change sets, wherein the storefront server system is configured to serve the virtual storefront based on the modified virtual storefront data via the computer network for display on each of the plurality of client devices.

In another embodiment, an example method for bundling goods at a storefront server system of an electronic commerce system is provided. The method comprises, in a setup phase, receiving bundle data from a production server, the bundle data comprising one or more bundles comprising one or more goods associated with a non-bundle price, the bundle data further comprising, for each bundle, a sale price based on the goods grouped into the bundle. The method further comprises, in a transaction phase, receiving from a client device a request to download a virtual storefront comprising a purchasing interface; serving, in response to the request, the virtual storefront based on virtual storefront data; and receiving from the client device via the purchasing interface a purchase request for one or more of the bundles. Additionally, the method comprises, in a post-transaction phase, ungrouping the one or more goods from the bundle, and calculating, for each good, an apportioned price comprising a ratio of the non-bundle price of the good versus the non-bundle price of all other goods in the bundle.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of an electronic commerce system with a staging to production feature, bundles feature, and price lists feature.

FIG. 2A illustrates a typical change set workflow utilized by the staging to production feature of the system of FIG. 1.

FIG. 2B illustrates a user interface for creating a change set.

FIG. 2C illustrates a user interface for adding objects to a change set.

FIG. 2D illustrates a user interface for locking a change set.

FIG. 2E illustrates a user interface for alerting a user to a new change set state.

FIG. 3 illustrates a process flow depicting an embodiment of a method for updating a production system from one or more change sets.

FIG. 4 illustrates a database model showing bundle extension of the product model, as utilized by the bundles to price lists feature of the system of FIG. 1.

FIG. 5 illustrates an example user interface for defining bundles.

FIG. 6 illustrates a parent bundle with “select all” containing nested bundles with “select n”, as utilized by the bundles to price lists feature of the system of FIG. 1.

FIG. 7 illustrates an example user interface for defining price adjustments.

FIG. 8 illustrates an example purchasing interface.

### DETAILED DESCRIPTION

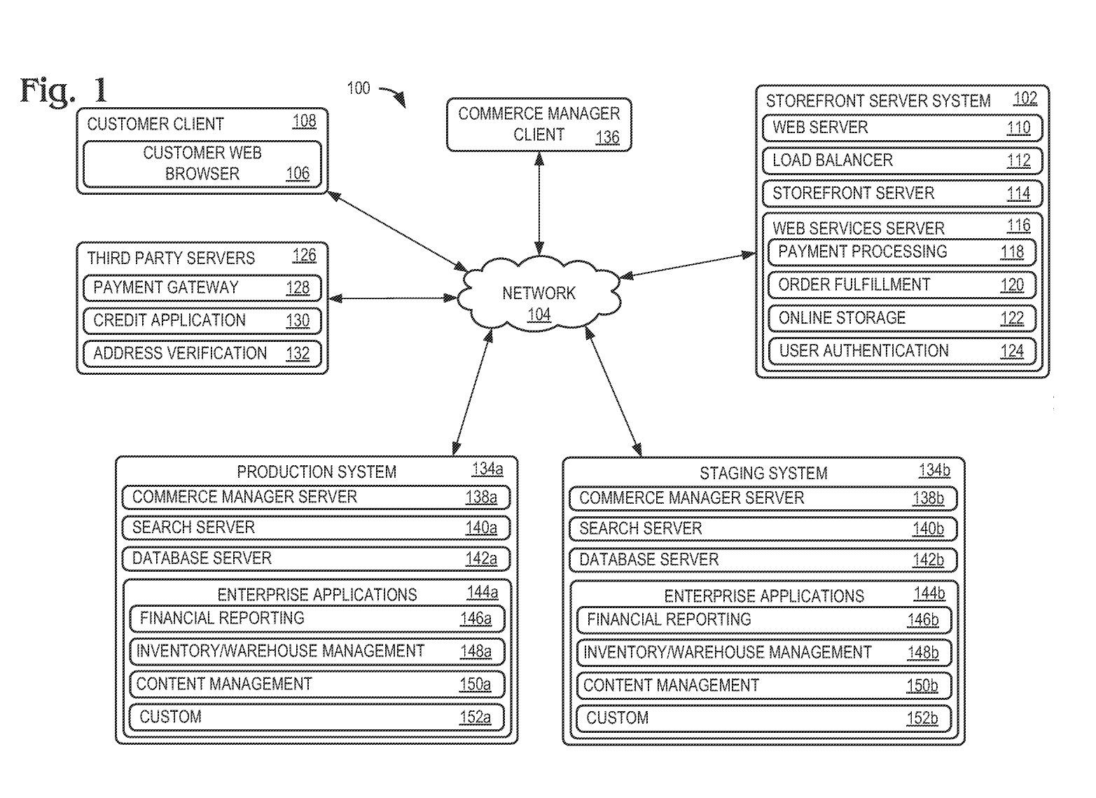

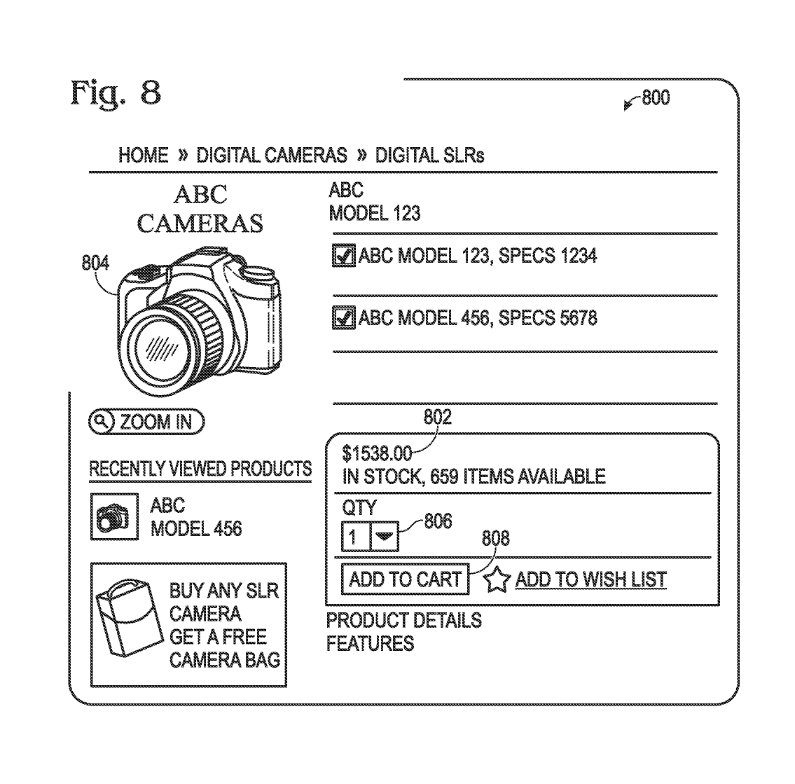

An electronic commerce system 100 with staging to production and bundles features is illustrated generally in FIG. 1. System 100 includes a storefront server system 102 providing a virtual storefront (e.g., purchasing interface 800 of FIG. 8). The virtual storefront may be defined by virtual storefront data stored in a data store of storefront server system 102. The storefront server system 102 may be accessed via network 104 by a customer web browser 106 executed on a customer client 108. In order to provide the virtual storefront, the storefront server system 102 may include a web server 110, such as Apache, and a load balancer 112 for directing HTTP sessions from remote customers to one of a plurality of storefront servers 114. Typically, the web server 110 will serve common elements of a website, such as banner graphics, etc., to the customer web browsers 106, while state-specific transactions, such as the presentation of an electronic catalog and the management of an electronic shopping cart, may be served by the storefront servers 114. In other embodiments, the storefront may be accessible through a native application program on customer client 108. As such, a protocol other than HTTP may be used.

Storefront server system 102 may further include web services server 116. The web services server 116 may host web services that provide payment processing 118, order fulfillment 120, online storage 122, user authentication 124, and/or other functionalities. It will be understood that the elements of server system 102 may be stored on a plurality of individual servers in any combination.

The electronic commerce system 100 may include a variety of third party servers 126 hosting third party web services. The third party servers 126 may provide one or more features not provided by storefront server system 102. For example, third party servers 126 may include a payment gateway 128 for processing payments for orders placed via the storefront server system 102, a credit application server 130 for enabling a customer to apply for credit for a purchase to be made via the storefront server system 102, and/or an address verification server 132 for verifying all or part of the address of a customer making an online purchase via the storefront server system 102. It will be understood that servers 128, 130 and 132 may, in whole or in part, be contained on the same physical server and/or combination of servers. It will be further understood that one or more of the features provided by third party servers 126 may be provided by one or more components of storefront server system 102.

System 100 includes production system 134a to enable the operator of the storefront server system 102 to develop and manage the storefront(s) presented thereby. Production system 134a may include one or more servers configured to interact with storefront server system 102 to provide the virtual storefront. While storefront server system 134a provides the user interface for the virtual storefront, production system 134a provides the remaining functionality. Production system 134a may include commerce manager server 138a, search server 140a, and database server 142a, in one example. Commerce manager server 138a may be configured to interface with commerce manager client 136. Search server 140a may be configured to provide search functionality for the virtual storefront. Database server 142a may be configured to interact with one or more databases utilized by system 100 (e.g., customer account history). In other embodiments, production system 134 may also include a central file repository and/or any other suitable server.

Production system 134a may further include various third party enterprise applications 144a, such as financial reporting applications 146a, inventory and warehouse management applications 148a, a content management system 150a, and/or custom applications 152a. In other embodiments, enterprise applications 144a may also include data warehousing systems, legacy systems, and or any other suitable system used by the operator's business.

As indicated, electronic commerce system 100 further includes staging system 134b. Staging system 134b may provide an environment wherein one or more proposed changes to production system 134a may be “debugged” before application to production system 134a. Staging system 134b includes components corresponding to those of production system 134a (corresponding components are designated with the same reference number, but with the suffix “b”). In some embodiments, all or part of staging system 134b may be contained on the servers of production system 134a, and vice versa.

In some embodiments, interaction with one or more enterprise applications 144b may be simulated to provide desired data to other components of staging system 134b. For example, applications 144b may be simulated via a pre-defined data-set. In another example, applications 144b may be simulated via one or more external applications. In other embodiments, staging system 134b may be configured to interact with enterprise applications 144a of production system 134a in order to access “real world” data. It will be further understood that these scenarios are presented for the purpose of example, and are not meant to be limiting in any manner.

In order to manage the other elements of electronic commerce system 100 (e.g., production system 134a, staging system 134b, or storefront server system 102), electronic commerce system 100 further includes commerce manager client 136. Commerce manager client 136 may access production system 134a and/or staging system 134b via network 104. For example, administrative users may configure lower level system settings, such as search engine optimizations, system configuration parameters, user accounts, payment gateways, and the like stored on production system 134a through commerce manager client 136. Similarly, Customer Service Representatives (CSR) may use commerce manager client 136 to manage customer orders.

While network 104 is illustrated as a single network, it will be understood that network 104 may be any suitable network or combination of networks and/or subnetworks, both logical and physical. Network 104 may further comprise one or more firewalls for additional security. In some embodiments, components of system 100 may be connected via a wide area network (WAN), such as the Internet. In other embodiments, storefront server may be located on a Demilitarized Zone (DMZ) subnetwork for security. In other embodiments, commerce manager client 136 may access production system 134a and/or staging system 134b via, at least in part, a Virtual Private Network (VPN). It will be understood that these networks are presented for the purpose of example, and are not intended to be limiting in any manner.

Using the various components of production system 134a and/or staging system 134b, the operator of system 100 may create and manage different features of the virtual storefronts hosted by the storefront server system 102. In the following paragraphs, various aspects of three particular features, namely a staging to production feature and a bundle feature of system 100 will be described. In some embodiments, these functions may be implemented by software executed on one or more of the production system 134a components, such as the commerce manager server 138a.

### 1. Staging to Production

Electronic commerce system 100 may be configured to provide many potential benefits, one of which is described via the following example scenario. A business needs to change the prices of 200 different products in the storefront on a specific date. Using conventional systems, each price may be changed on the production server on that date. However, such an operation may be very time-consuming. Furthermore, and more importantly, any errors may be displayed immediately to shoppers, which may have negative consequences for the business.

A better practice may be to apply the changes in a staging environment, validate them, and then move them in bulk to the production environment. However, managing changes across environments may be complicated and time-consuming. For example, it may be difficult to know which objects are ready to be moved to production. As another example, it may be difficult to ensure modified objects are prevented from being changed again before they are moved to the production environment.

Moving information from one system to another is not a new problem and many solutions have emerged in response. Current solutions are detailed below, though all pose significant drawbacks for complex systems with many object dependencies.
1. File system copy: Creates an exact copy of information, but is unaware of objects or their dependencies, thus making it difficult and error prone for partial synchronization.
2. Database copy: Database contents may be exported from one system and imported into another, which can have the effect of synchronizing two systems. Problems arise when internal constraints within the database become inconsistent, such as automatic identifiers, as the two systems have different series updates. Further, this approach does not manage external systems or objects nor does it manage series of changes in a unified way.
3. Application import/export: Applications may provide a mechanism to import and export application information, and, as part of the process, verify imported information for consistency. Typical uses for such import-export tools may include migrating data between environments (e.g., from development to staging, from staging to production, etc.), exporting data to third party applications, and importing data from third-party applications. As such, this approach is well suited for bulk updates and complete replication but cannot coordinate multiple, related synchronizations. This approach also cannot offer fine grained verification, conflict resolution, user permission and scheduling, which may be required for staging to production synchronizing.
4. Synchronization tools: Tools like rsync use meta-information like timestamps and file names for synchronization; however they cannot manage complex synchronization tasks because they do not understand object dependencies.
5. Manual updates: A skilled user may make changes to one application instance to replicate the state of another. Aside for the large amount of effort to keep the systems synchronized, the process is error prone, and becomes increasingly untenable as the number of objects and dependencies increase.

To address the shortcomings of these approaches, among others, system 100 may be configured to provide a staging to production feature by utilizing change sets. Such a system will now be discussed in more detail.

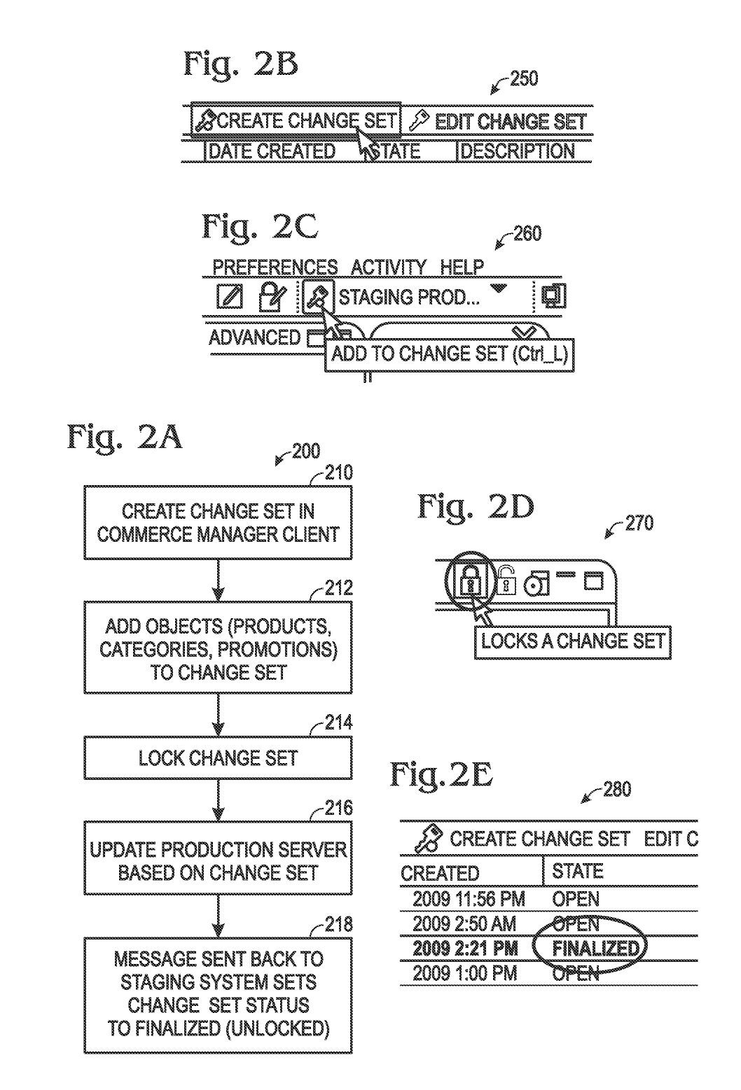

FIG. 2A illustrates a change set workflow 200 of an example staging to production feature of system 100 of FIG. 1. While only a Single change set is currently described, it will be understood that more than one change set may be exist concurrently. Workflow 200 includes, at 210, creating a change set via a commerce manager client (e.g., commerce manager client 136 of FIG. 1). Change sets are stored on a staging server system (e.g., staging system 134b of FIG. 1), and allow for temporarily grouping objects and controlling who can modify them. In some embodiments, a user may need permission to manage change sets. For example, this permission may be associated with the user's role, and may be controlled by an application administrator. In some embodiments, such as where an external user management system is used, the permission may be controlled by a user administrator.

Both existing and new objects may be added to a change set. When adding new objects into a system which has change sets enabled, a change set must first be specified to associate the one or more new objects with. This is done to ensure that objects created in the staging environment will not be “forgotten” when an update to the production server occurs. FIG. 2B shows an example user interface 250 for creating a change set.

Returning to FIG. 2A, workflow 200 includes, at 212, adding (“grouping”) objects to the change set. For example, FIG. 2C shows an example user interface 260 for adding objects to a change set. There may be any number of object types, and each type may have a separate set of requirements for synchronizing between systems. Objects of different types may be added to a change set, provided the user is permitted to manage those objects within a change set. An object may be removed from a change set or moved to a different change set. Adding an object to a particular change set results in that object being “locked” to that change set until that change set has been applied. As such, a locked object cannot be modified by any other change set.

Objects may be classified as either unmanaged objects or managed objects. Managed objects are objects stored by an application in a database or other information store supporting object relationships. Applications are aware of managed objects and their dependencies since the objects and the dependencies arise from the applications themselves. Examples of objects that can be managed with change sets include virtual catalogs, categories, products, product SKUs, promotions, price lists, price list adjustments, base amounts, dynamic content, dynamic content deliveries, and saved conditions.

Unmanaged objects are objects contained in externally managed systems (e.g., content management systems). Applications may have an awareness of the dependencies, but may only have limited control in resolving the dependencies. In addition, the applications may not be aware of complex dependencies, such as transitive relationships.

Once a change set is created, it may be modified until it is locked. The schedule may be modified or deleted, the change set object may be moved to another change set, or the change set may be sent through a workflow process with additional approvals and verifications. In some embodiments, change set operations may be recorded in audit log. There may be a single audit log for all change sets, or there may be individual audit logs for each change set.

A change set may be applied immediately or scheduled to execute at a later time. Scheduling may be used to manage complex change set dependencies or implement additional verification and approval steps. For example, when a change set is created, it may contain dependencies that cannot be resolved until the change set is scheduled. In some instances, the change set schedule and the change set objects' active time may not overlap. For example, a promotion with an active time between March 1 and March 15 may be in a change set with schedule of February 20. Using two levels of scheduling in this way allows for decoupling of life time from active time.

All change sets scheduled at a given time need to be evaluated together to determine what, if any, static conflicts exist. Such evaluation will be discussed below. Scheduling may also help with operational concerns, such as where policy dictates changes to production systems are limited to defined time periods. For example, changes may be made when traffic is low, or when extra operational staff is on duty to handle any unexpected issues.

Returning to FIG. 2A, workflow 200 includes, at 214, locking the change set. When all changes have been made, the change set is locked on the staging instance. In contrast to locked objects, which can be still be modified by their associated change set, the objects of a locked change set can no longer be modified. Locking a change set may provide many potential benefits. For example, locking a change set may ensure that the change set is not modified before being applied. As another example, locking a change set may signal that the change set is ready to be moved from staging to production. FIG. 2D shows an example user interface 270 for locking a change set.

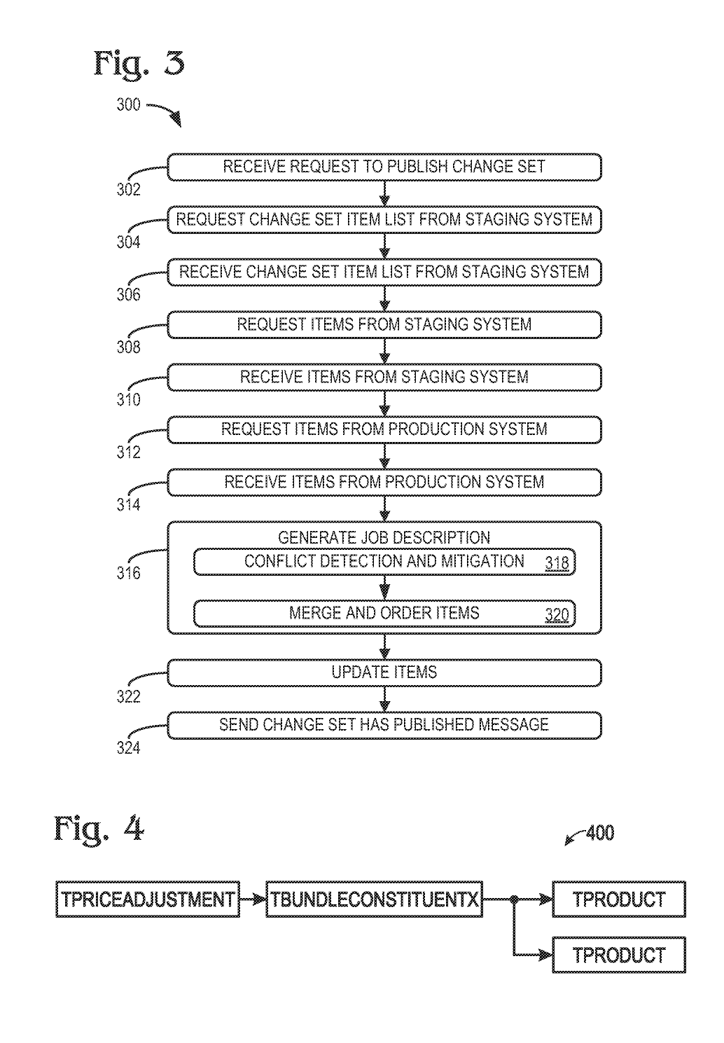

Returning to FIG. 2A, workflow 200 includes, at 216, updating the production system based on the one or more change sets on the staging system. FIG. 3 illustrates a process flow depicting an embodiment of a method 300 for updating a production system from one or more change sets. Such an update (also known as “merging”, “syncing”, or “exporting/importing”) may be completed using a Data Sync Tool (DST) program. The Data Sync Tool is responsible for merging changes from one environment (e.g., the staging system) to another (e.g., the production system). During the updating, both staging and production servers may remain available and able to function as live servers.

Method 300 includes, at 302, receiving a request to publish the change set. Such a request may be generated by a client device (e.g., Commerce Manager Client 136 of FIG. 1) or may be programmatically generated (e.g., based on a previously-defined schedule).

At 304, method 300 includes requesting a change set item list from the staging system. In response, at 306, method 300 includes receiving a change set item list from the staging system. At 308, method 300 includes requesting items from the staging system. In response, at 310, method 300 includes receiving items from the staging system. At 312, method 300 includes requesting items from the production server. In response, at 314, method 300 includes receiving items from the production server.

At 316, method 300 includes generating a job description based on the data received at 306, 310, and 314. The job description includes one or more instructions configured to effect the changes contained in the one or more change sets. For example, the job description may contain a list of exported objects from the staging system and the actions to perform on each one as it is brought into the production system (e.g., add, update, or delete). Generating a job description includes, at 318, detecting one or more conflicts resulting from one or more dependencies. Example dependencies and resulting conflicts will now be discussed in greater detail.

Some objects have dependencies on other objects, and when the DST is used to move objects from one system to another, all dependencies of that object must exist on the target system. If not, the operation may fail and/or or the final system may be in an inconsistent state after the synchronization process. For example, if a new product is ready to be moved from a staging system to a production system, but the category that contains that product is also new and does not yet exist on the production system, any attempt to move the product to the production system before moving the category will fail.

In another example, wherein the managed object is a product, one or more associated objects must exist on the production system in order to synchronize the product. The one or more associated objects may include, but are not limited to, associated categories and catalogs (e.g., master catalogs and virtual catalogs), product type, brand, tax code, SKU options, SKU option values, as well as some file system assets (e.g., associated images).

In another example, wherein the managed object is a Price List Assignment (PLA), the corresponding price list which will be referenced must exist on the production system in order to synchronize the PLA.

Objects that relate to another object are referred to as dependent and must be managed in such a way as to avoid conflicts. A dependent object has either weak or strong dependencies to other objects. Weak dependencies do not lead to an inconsistent system state when dependencies are not resolved. An example of a weak dependency is a parent-child relationship in a hierarchical structure. Here, a parent object is weakly dependent to child objects. In other words, the parent is valid without its children. In contrast, a child object is strongly dependent to its parent object, thus resulting in an inconsistent state when the dependency is not resolved.

Objects may be independent and therefore have no dependencies on other objects. However, such independent objects may still participate in another object's dependencies. Synchronizing these objects does not result in inconsistent system state or synchronization operation failure.

A conflict may arise when an object has a dependency that cannot be resolved. Dependencies may either be statically detectable or dynamically detectable. When a dependency can be determined before a change set is applied to the production system, the dependency is statically detectable. Unresolved dependencies arising while a change set is being applied are dynamically detectable. Dynamically detected conflicts arise when unmanaged objects' dependencies aren't fully understood or the DST incorrectly assumes the target system state will resolve a dependency when in fact it cannot. As a matter of practicality, unresolved weak dependencies may not generate errors or warnings.

To determine whether a statically detectable change set conflict exists, each object in the change set is examined for dependencies, and those dependent objects are recursively searched until all objects and dependencies are identified. An object's dependency may be resolved by an object in the same change set or by an object in a different change set scheduled before the current change set. A change set with a dependency on a later change set is a conflict. Determining and eliminating static conflicts may prevent those conflicts and the resulting change set failure received when they are applied.

Some unresolved dependencies cannot be determined until the change set is applied. In such a case, the change sets that would result in inconsistent state may not be applied, and an error may be produced.

Generating a job description further includes, at 320, merging change sets and ordering items in the job description to resolve any conflicts detected at 318. For example, changes to independent objects may be ordered before changes to dependent objects. Conflicts may further be resolved by consolidating the individual change sets into a consolidate change set.

The manner in which the production system is updated is determined by the merging and ordering of 320. For example, in some embodiments, the production system may be updated as a single transaction. In other embodiments, the production system may be updated via several sub-transactions and appropriate partial-failure logic. The partial logic may be configured to, in the event of a failure of one sub-transaction, perform the remaining sub-transactions, if possible. Such partial failure logic may prevent low priority change failures from delaying higher priority changes.

Further conflicts may arise from the use of multiple change sets (e.g., when users without sufficient permissions to resolve conflicts are working independently of each other). In some embodiments, change sets may be created by users with granular user permissions, while an administrator class of users with broad user permissions may manage the resolving of conflicts.

Multiple change sets with interdependencies may result in cyclical dependencies. A cyclical dependency, in the simplest case, occurs when a first object and a second object are mutually dependent and located in different change sets. To resolve conflicts from objects with cyclic dependencies, the conflict objects may be merged into a single change set, and therefore applied as a single operation. The DST may be configured to determine when cyclic dependencies exist. The DST may be further configured to suggest to the user one or more modifications to eliminate such dependencies. It should be noted that there is always at least one viable solution to cyclic dependencies, and that is to combine all change sets into a single change set. However, simpler (e.g., less intensive) methods involving reordering and/or combination may exist. When evaluating a large number of change sets with a large number of objects and relationships, performance may be improved by caching the results of the object dependency evaluations so a given object's dependencies only need to be determined once.

Once all conflicts have been resolved and the job description has been generated, method 300 includes, at 322, updating the production system. Updating may be accomplished, for example, by passing the job description and binary data comprising the updated objects to the production system. At 324, method 300 includes sending a message indicating the change set has been published. The user may be presented to the user, or may be transparent to the user.

In some embodiments, method 300 may be performed by the DST in a single execution. In other embodiments, such as where the source and target systems cannot communicate directly (e.g., due to firewall rules), the DST may perform the merger in two executions, where each execution comprises one or more elements of method 300. In the case of a two-step export/import, the DST may first be run from a location that has access to the source instance's database. The change set data is exported to the DST file system. The exported package may then be moved to another machine from which the DST has access to the target instance's database.

Returning to FIG. 2A, workflow 200, at 226, includes receiving a message indicating the change set has been applied. As described above, the message may be presented to the user, or may be transparent to the user. When the message is received, the items on the source system (e.g., the staging system) belonging to the change set may change from a Locked to a Finalized state (essentially unlocked). As such, unlocked items may be added to a new change set. In other embodiments, the promotion of change set status may be determined by the workflow used by the individual operator. For example, while one organization may want the items in a change set to be “Finalized” (unlocked) immediately after the change set has been successfully moved, another might want the change set to stay in a Locked state on the source system awaiting further verification. FIG. 2E shows an example user interface 280 for alerting a user to a new change set state. Interface 280 comprises a summary of current change sets including a time stamp and a current state. As illustrated, the “state” column has been updated for one of the change sets to display “finalized”. In other embodiments, such an alert may comprise a graphical alert, an audible alert, a textual alert, or a combination thereof. It will be understood that these alerts are presented for the purpose of example, and are not meant to be limiting in any manner.

While the above discussion in reference to FIGS. 2 and 3 was directed towards a “staging to production” feature, it will be appreciated that workflow 200 and method 300 may be used, with minimal modification, to provide a “staging to preview” feature. A “staging to preview” feature may provide a preview system to verify one or more change sets before said change sets are applied to a production system. In contrast to the “debugging” of change sets offered by the staging system, a “staging to preview” feature allows for previewing the actual updated production system state that will be presented to the customers. As with the “staging to production feature”, a “staging to preview” feature may be accomplished via the updating of a preview system via a DST based on one or more change sets of a staging system.

The above-mentioned preview feature may be performed on a preview server, which may be contained, in whole or in part, on the staging system (e.g., staging system 134b of FIG. 1) or on the production system (e.g., production system 134a of FIG. 1). The preview server may be configured to provide a base view equivalent to the unmodified production system. A user of the preview system may then be able to review one or more scenarios, each scenario comprising the application of one or more change sets. For example, a first scenario may comprise the application of a first change set, while a second scenario may comprise the application of the first change set and a second change set.

### 2. Bundles

In an e-commerce system, it will be understood that objects may not only be individual products for sale, but also groups (“bundles”) of products. Bundles are collections of products that are sold and marketed together under a single product code, but are also products themselves. Bundling is a marketing strategy that involves offering several products for sale as one combined product. Typically, a bundle is comprised of one main product and several related products. For example, a digital camera may be the main product, while a camera case and an extra battery pack may be related products. The bundled products generally offer a discount when compared with purchasing all the products individually. Bundling may be used to increase the average order size by providing savings that entice a shopper to purchase more.

Since bundles are products themselves, anything that may be done with a regular product may be done with a bundle as well. A bundle may have associated search engine optimization terms and merchandising associations assigned to them so that inventory can be tracked either by bundle or by the items within the bundle. It may be managed as a single entity in the catalog. Pricing may be assigned to it. It may be associated with other products to use it as a cross sell or up sell, for example. It may be promoted, featured, searched for, etc.

A bundle may show up in searches or other lists of products, and its details may be viewed in the context of a product details page. Just like other products, bundles may be added to a cart with a single click of a button. In some embodiments, bundles may be presented in the virtual storefront using a bundle-specific template. Further, in some embodiments, a setting may exist which returns bundles first in any relevant search results under the assumption that a larger order size is always a safe default goal. For example, if a shopper searches for “video game console”, the bundles containing video game consoles may be shown above the video game consoles themselves.

Just like regular products, bundles may be imported and exported via XML import/export. When a bundle is exported, the exported information may include the product code for the bundle and the product codes for the bundle constituents. Associated categories may be automatically exported, as well as the catalogs associated with those categories. Like a regular product, associated assets, inventory and product associations may be optionally exported. If a product bundle is imported into a target system that has a product bundle with the same product code, all bundle items of the target bundle may first be cleared and the bundle items in the import file may then be written in their place.

The bundle itself may be modeled as a product, albeit with extended capabilities. For example, FIG. 4 illustrates a database model 400 showing bundle extension of the product model. The ProductBundle class may be an extension of the Product class. The distinction between the two is, despite both being stored in TPRODUCT database table, a bundle uses a JPA discriminator ProductBundleImpl. Another distinction is the selection rule used to determine if a bundle is fixed or dynamic, which will now be discussed in greater detail.

Bundles may be classified as either fixed or dynamic. A bundle whose items and item quantities is predefined by the merchant and cannot be modified by the shopper is called a fixed bundle. In contrast, dynamic bundles allow the customer to make selections within a bundle as to what they want to purchase. The customer is not required to purchase all of the items offered in the bundle, but rather a subset of the items. This type of bundle is commonly used in TELCO scenarios. For example, a dynamic bundle may include a mobile phone with a choice of plans and add-on services. The shopper may be able to select a phone along with one plan and perhaps a few add-on services.

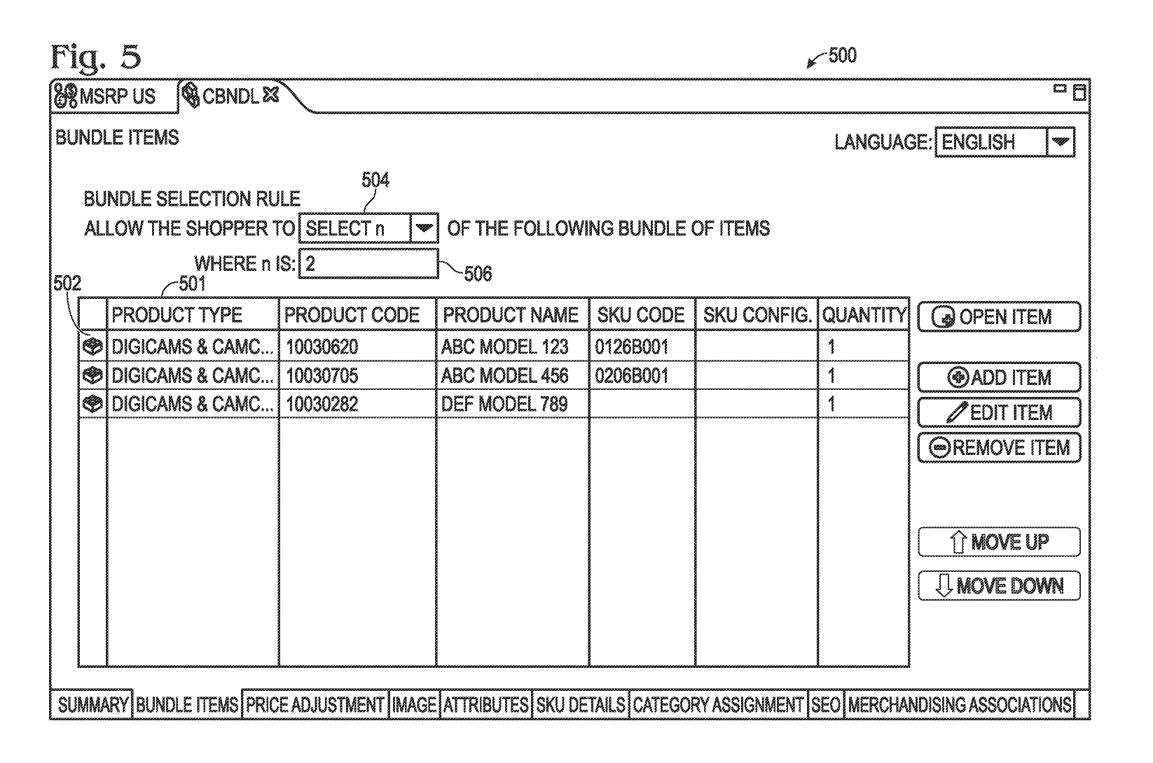

Bundle behavior may be defined through one or more bundle selection rules. For example, FIG. 5 shows an example user interface 500 for defining bundles. User interface 500 includes element 501 for defining one or more bundle items 502 of the bundle. User interface 500 further includes selection rules 504. Selection rules 504 may include, but are not limited to, “select all” and “select n”. The “select all” rule defines that all items in the bundle are tied together, thus resulting in a fixed bundle. The “select n” rule defines a dynamic bundle, wherein an “n” number of items, denoted by number 506, may be selected by the customer.

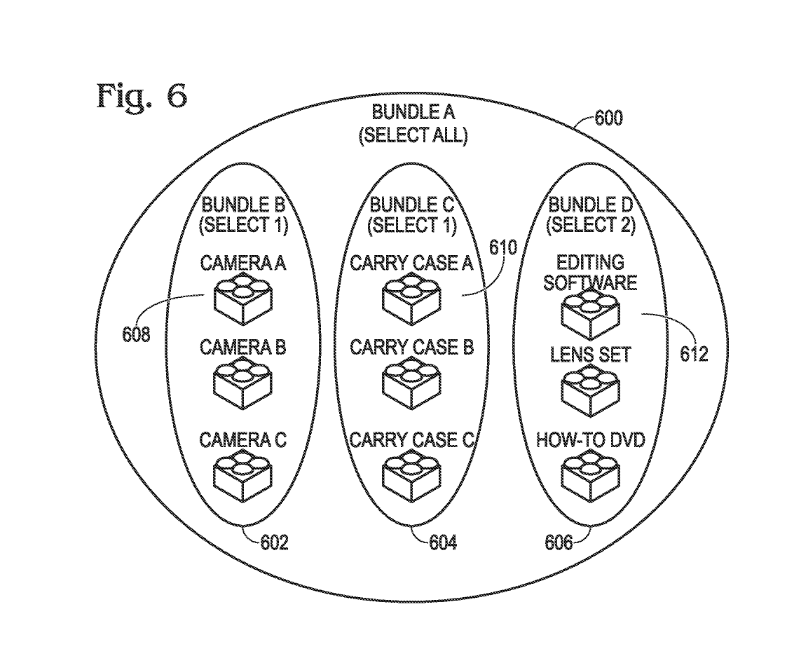

Bundles may contain other bundles. Such bundles are called nested bundles. Nesting may provide extra flexibility in both offering and managing bundles. Smaller, building-block bundles may be re-used across many parent bundles. For example, FIG. 6 illustrates a parent bundle 600 with “select all” containing nested bundles 602, 604, and 606 with “select n”, as utilized the system of FIG. 1. Specifically, bundle 600 may include any one of items 608 from bundle 602; any one of items 610 from bundle 604; and any two of items 612 from bundle 606.

While infinite levels of nesting may be supported, nesting may be restricted, for practical purposes, to a certain number of levels (e.g., three levels) in some embodiments. Nesting bundles may allow for some very complex product configurations. However, this functionality may also result in one or more circular references. For example, a customer may inadvertently attempt to add an item to a bundle, only to find that the item being added already contains another item from the parent bundle (the parent bundle may contain a mix of fixed and dynamic bundles). The ecommerce system may not allow bundles containing such circular references to products to be saved.

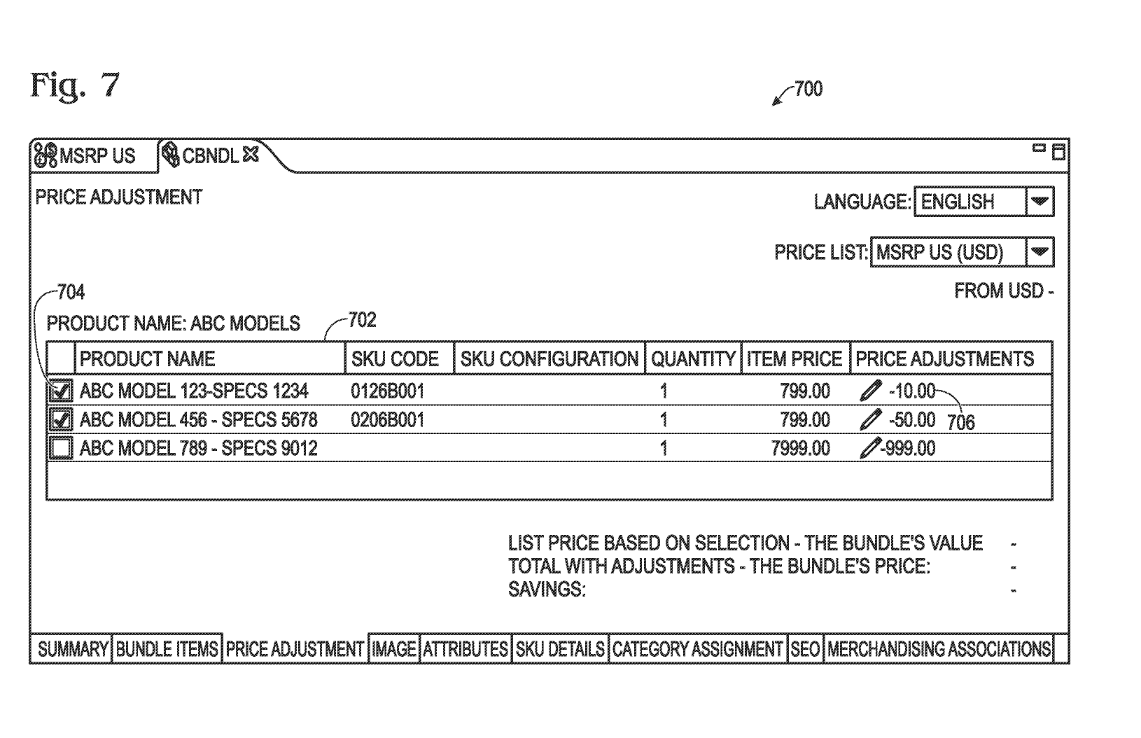

Pricing is handled differently for fixed bundles and dynamic bundles. For example, fixed bundles are priced by assigning a price to the parent bundle. Pricing for dynamic bundles may comprise “price adjustments” used to define the difference in price between various bundle items. For example, if one of the choices in a bundle costs more than the rest, an additional charge may be added on top of the base bundle price if the more expensive item is selected by the customer. Price adjustments may be modeled as base prices residing in price lists. Such price adjustments may be displayed via the Price Adjustment tab of the product editor for dynamic bundles. For example, FIG. 7 shows an example user interface 700 for defining price adjustments. Interface 700 includes element 702 for defining one or more products 704 with price adjustment 706.

Prices for dynamic and fixed bundles may be retrieved using standard pricing APIs (e.g., using PriceLookupFacade). Bundle price may be set on the bundle product code in a price list. In contrast, price adjustments for dynamic bundles may be made on individual bundle items within the context of the given bundle. The same price list that is used to lookup the bundle price may be used to look up the adjustment price. Pricing for bundles, including price adjustments and price apportioning, will now be discussed in greater detail.

In the early stages of the e-commerce lifecycle (e.g., catalog management, display in the storefront, etc.), the emphasis may be on the bundle that knows about its items. However, in the downstream stages (e.g., order processing and fulfillment), the emphasis may be on the items that know about their parent bundle. Therefore, a bundle may be viewed at the virtual storefront as a monolithic product, but the actual order and the fulfillment thereof may be treated as a collection of individual items. Treating the individual bundle items separately after the transaction may allow for extra flexibility, such as when dealing with varying delivery times. For example, bundles that are a mix of physical and digital goods may be merchandized and sold as a bundle even though the digital goods may be delivered right away, while the physical goods may be delivered at a later time.

To be able to ship items separately and/or accept returns and exchanges, Apportioned Pricing for each item may be used. Apportioned pricing defines the individual price for each bundled item. After checkout, the bundle may be exploded out into individual SKUs. The total price of the bundle may be apportioned across the bundle items by calculating the ratio of the item's non-bundle price versus the non-bundle price of all other items in the bundle. Any product-level discounts on the bundle may be taken into account when this apportioning is calculated. An example Apportioned price (AP) formula is as follows:

AP=(BP×CP)/SUMCP wherein,
BP=bundle price
CP=bundle item price
SUMCP=sum of all bundle item prices

Like pricing, tracking inventory of bundles and their constituent items may require extra consideration. In some embodiments, inventory for both dynamic bundles and fixed bundles may be calculated based on the “worst-case scenario”. For example, the inventory of each bundle item may be queried, and the lowest inventory value may drive the inventory display for the parent bundle. For dynamic bundles, this same approach may be taken, but the inventory calculation may not take into account the specific customer selections.

The inventory calculation may be accessible via one or more APIs. For example, SellingChannelInventoryService may be used to iterate through the bundle tree to determine the available inventory. This service may be customized to retrieve numbers from an external system, such as an Enterprise Resource Planning “ERP” system.

The inventory status may determine if a product is available on pre-order, backorder, only if in stock or always available. This status may determine how the product is presented in the Storefront and/or the look of the “add to cart” button.

FIG. 8 illustrates an example purchasing interface 800 of the system of FIG. 1. Interface 800 may be served to customer's web browser (e.g., web browser 106 of FIG. 1) after the customer requests to download the virtual storefront. Interface 800 comprises a displayed price 802 for product 804. The displayed price may be based on the list price and/or the sale price. Interface 800 further comprises an unconfirmed quantity 806. Quantity 806 may be a user-selectable element or combination of elements (e.g., list, text input box, check box, slider, or radio button) allowing the user to specify an unconfirmed purchase quantity. An add to cart selector 808 is provided to enable a customer to ad the selected product in the selected quantity to the customer's online shopping cart, from which point the customer pay proceed to enter payment and shipping information, and ultimately purchase the product.

The subject matter of the present disclosure includes all novel and nonobvious combinations and subcombinations of the various processes, systems and configurations, and other features, functions, acts, and/or properties disclosed herein, as well as any and all equivalents thereof.

1. An electronic commerce system, comprising:
a storefront server system configured to serve a virtual storefront over a computer network for display on each of a plurality of client devices;
a data store in which virtual storefront data for serving the virtual storefront is stored, the virtual storefront data including one or more objects grouped to each other having one or more dependencies among them;
a staging server system configured to receive one or more change sets from a user of a commerce manager client, the change set comprising changes to the one or more objects;
a synchronization program configured to generate a job description comprising one or more instructions to effect the one or more changes, generating the job description comprising resolving conflicts within the change sets and conflicts between the change sets, merging the change sets, and ordering the changes included in the one or more changes sets;
a production server system configured to receive the job description via the synchronization program and modify the virtual storefront data to reflect the job description and the one or more change sets;
wherein the storefront server system is configured to serve the virtual storefront based on the modified virtual storefront data via the computer network for display on each of the plurality of client devices.

2. The electronic commerce system of claim 1, wherein the staging server system is further configured to provide one or more user-selectable previews, each preview comprising one or more change sets.

3. The system of claim 1, wherein the staging server is configured to temporarily group the one or more objects into the one or more change sets to generate the one or more change sets, and wherein after the job description is received by the production server, the staging server is configured to ungroup the one or more objects from the one or more change sets.

4. The electronic commerce system of claim 1, wherein resolving conflicts comprises modifying the order in which changes are applied such that changes to independent objects are made before changes to dependent objects.

5. The electronic commerce system of claim 1, wherein resolving conflicts comprises combining the one or more change sets into a consolidated change set.

6. The electronic commerce system of claim 1, wherein the one or more change sets have a scheduled time during which the one or more change sets are applied on the production server.

7. The electronic commerce system of claim 6, wherein the change set scheduled time and the objects the change set contains have active times that do not overlap.

8. The electronic commerce system of claim 1, wherein the user is a user having a permission to modify the one or more change sets, the permission associated with a role of the user in the electronic commerce system, the permission controlled by an administrator of the electronic commerce system.

9. The electronic commerce system of claim 1, wherein the one or more objects include one or more of a virtual catalog, a category, a product, a product SKU, a promotion, a price list, a price list assignment, a base amount, a dynamic content, a dynamic content delivery, and a saved condition.

10. The electronic commerce system of claim 1, wherein the job description comprises a single transaction.

11. The electronic commerce system of claim 1, wherein the job description comprises a first sub-transaction, a second sub-transaction, and partial-failure logic, the partial-failure logic configured to perform the second sub-transaction independent of a failure of the first sub-transaction.

12. The electronic commerce system of claim 1, wherein receiving the job description via the synchronization software comprises moving the job description and the one or more change sets to a system that has access to the production server.

13. The electronic commerce system of claim 1, the synchronization software being further configured to provide a message indicating the one or more change sets have been applied to the production server system.

14. The electronic commerce system of claim 1, wherein the virtual storefront is accessible via a web browser.

15. The electronic commerce system of claim 1, wherein the virtual storefront is accessible through a native application program.

16. The electronic commerce system of claim 1, wherein the staging server system is further configured to record each modification to the one or more change sets in an audit log.

17. A method for bundling goods at a storefront server system of an electronic commerce system, the method comprising:
in a setup phase:
receiving bundle data from a production server, the bundle data comprising one or more bundles comprising one or more goods associated with a non-bundle price, the bundle data further comprising, for each bundle, a sale price based on the goods grouped into the bundle, and in a transaction phase:
receiving from a client device a request to download a virtual storefront comprising a purchasing interface,
serving, in response to the request, the virtual storefront based on virtual storefront data, and
receiving from the client device via the purchasing interface a purchase request for one or more of the bundles;
in a post-transaction phase:
ungrouping the one or more goods from the bundle, and
calculating, for each good, an apportioned price comprising a ratio of the non-bundle price of the good versus the non-bundle price of all other goods in the bundle.

18. The method of claim 17, wherein a bundle comprises one or more nested bundles.

19. The method of claim 17, wherein the one or more goods comprise one or more of digital goods and physical goods.

20. The method of claim 17, further comprising, in the setup phase, defining the behavior of each bundle via one or more selection rules comprising a “select all” rule defining that all goods in the bundle must be purchased together and a “select n” rule defining an n number of items to be selected by a customer.
